(19) United States
(12) Patent Application Publication
(10) Pub. No.: US 2011/0008755 A1
(43) Pub. Date: Jan. 13, 2011

(54) PLATE FORM OF DENTAL IMPLANT

(76) Inventor: Carl E. Misch, Birmingham, MI (US)

Correspondence Address: BROOKS KUSHMAN P.C., 1000 TOWN CENTER, TWENTY-SECOND FLOOR, SOUTHFIELD, MI, 48075, US

(21) Appl. No.: 12/501,880

(22) Filed: Jul. 13, 2009

(51) Int. Cl. A61C 8/00

(52) U.S. Cl. 433/176

(57) ABSTRACT

A dental implant assembly 10 for implanting an artificial tooth into the mouth of a patient. The dental implant assembly 10 has a lower component 12 including a foot 16, a core 18, a shoulder 22 and a neck portion 20. The lower component 12 is seatable in an upper component 14 that is detachably attachable to the lower component 12. A barrel-shaped body 36, 38 is included in the upper component 14. It has major 36 and minor 38 members that are juxtaposed and adapted to secure a prosthesis 34.

### BACKGROUND OF THE INVENTION

1. Technical Field

This invention relates to dental implants and, more particularly, to a blade or plate form endosteal dental implant that supports prosthetic teeth to replace missing teeth in edentulous ridges of the jaws.

2. Background Art

A dental implant may usefully support an artificial bridge, crown, tooth or other dental prosthesis (collectively herein, “prosthesis” or “prostheses”). Conventionally, one form of implant may have a plate or blade portion that is embedded in bone that underlies an edentulous span. A post typically extends upwardly from the implanted blade and supports the prosthesis.

This type of implant is often inserted by making an incision in the fibromucosal tissue down to the underlying alveolar ridge crest bone. The tissue is then opened to expose the bone. A burr may be used to create a groove in the bone which is as deep as the blade, which is then wedged into the bone. After insertion, the tissue is sutured about the neck of the implant so that the rest of the post protrudes above the tissue line. Typically, a few weeks or months may elapse before the prosthesis is attached to the post. During this period, bone starts to grow around the blade and through any holes or vents that may be provided in it, thereby anchoring the implant before it is subjected to stresses imposed by use.

Submergible blade implants, such as those described by A. L. Miller & A. J. Viscido in U.S. Pat. No. 4,177,562, allow a blade to be inserted in the jawbone for a long period of time before being placed in actual use. With this type of implant, the blade is completely submerged in the bone. It is then covered over and allowed to remain in place for several months. During this time, it is protected against being dislodged by the tongue or other teeth during mastication. Once there has been substantial regrowth of the bone over, around and through the submerged blade, the tissue is again opened and the post is attached to the blade by a typical screw-type connection.

It is common for oral implants to have a post with a neck portion which extends from the blade. Such a neck portion is typically narrower than the rest of the post and the blade. As a result, the narrow neck is often a weak spot in traditional oral implants. In use, such implants can bend in the area of the neck portion when chewing movements occur. This might cause bone resorption immediately below the neck portion and cause the neck to break.

Linkow disclosed a ring-type of implant in U.S. Pat. No. 3,465,441. The ring or plate form of implant presents several advantages. Because it primarily uses a horizontal plane for securement, rather than width and height as a root form implant, it may be utilized in long-term edentulous areas in spite of loss of bone width. The horizontal part of the plate form is supported by bone on each side and provides a large surface area of support in spite of moderate atrophy of the available bone width. The narrow endosteal body of the plate form implant conventionally has holes, vents, or slots. Thus bone can grow through the implant to increase the surface area for support. This augments vertical load-bearing ability.

Traditional plate form bodies were designed only for cement retention of the prosthesis and were primarily one-piece implant/abutment designs. They lacked an antirotational feature when two piece abutments where used. Some studies demonstrate that two abutment posts are more suited for force transfer. Because the two to three abutment posts are splinted together in the prosthesis, the amount of occlusal force is applied into more than one region of the implant. This reduces the amount of stress transferred at each site. Thus, two abutment posts were used whenever possible. However, these additional posts further elongate the implant and make it more difficult to place within a free hand osteotomy prepared into the edentulous site.

Some traditional plate form implant bodies are tapered, with the apical or base portion being narrower than the crestal portion. The wedge shape was required as the implant osteotomy was not prepared to full depth. Instead, the implant was driven into the bone as a nail is hammered into wood.

Biomechanical designs of the plate form implant very greatly. Initial photoelastic studies indicated that the open vented apex or base design is more stressful to bone than the closed border design. Traditional plate form designs include those with closed interior borders and open vents within the implant body. See, e.g., U.S. Pat. No. 3,465,441.

### SUMMARY OF INVENTION

The inventive implant design includes a bulging neck portion that increases the surface area of the implant which lies in contact with the denser crestal cortical bone and thus strengthens the implant's ability to resist lateral force. The crest of the edentulous ridge is more cortical and dense than the trabecular portion of the implant site. In addition, lateral forces applied to the implant result in greater stress in the crestal region. Thus, a step-type (bulging neck) transition area is defined between the post and the blade.

The inventive implant has a blade portion that defines curvilinear edges between which run laterally oriented ridges and horizontal valleys that increase the bone-implant surface area for force distribution. In addition, the horizontal valleys allow bone to be loaded in compression, rather than shear. Because bone is strongest in compression and weakest with shear loads, the inventive ridge-valley design offers significant advantages.

The width of the implant influences its ability to support vertically exerted forces. An implant that is twice as wide presents twice the compressive support area, if all other factors are equal.

For a given implant mass, tapered implant bodies have less surface area than parallel walled implants. The surface area of the implant may be increased by over 20% when the plate form width is equal from the crest to the apex. Therefore, the plate form implant body of the inventive design has a body that is as wide as the crestal portion of the implant.

As noted earlier, conventional metal plate forms of implants are often custom bent at the time of surgery to follow the curvature of the arch or the flare of the ascending ramus, allowing greater use of available bone. As a result, a softer grade of titanium was usually preferred. Thus, unlike conventional structures, the inventive blade form implant is not altered or bent during or after implant insertion, and thus is preferentially prefabricated from a material (e.g. a titanium alloy) which is more resistant to long term fracture.

In one embodiment, the mesio-distal length of the inventive implant is reduced to less than 12 mm. As a result, the osteotomy may be straight rather than curved. This facilitates implant insertion, since custom bending of the implant body is unnecessary.

### BRIEF DESCRIPTION OF THE DRAWINGS

FIG. 1 is an exploded perspective view of one embodiment of an implant assembly for securing a dental prosthesis according to the invention;

FIG. 2 also is a perspective view of the embodiment of the invention depicted in FIG. 1, taken from a vantage point slightly above and looking downwardly upon the embodiment depicted in FIG. 1;

FIGS. 3A-E respectively represent top plan, front, side, rear, and bottom plan views of the implant assembly depicted in FIGS. 1-2;

FIG. 4 depicts an alternate embodiment of the invention depicted in FIGS. 1-3, and illustrates an exploded perspective view, including an oblique or inclined bulging neck portion of a lower component thereof;

FIG. 5 is an exploded perspective view of the embodiment of the dental implant assembly depicted in FIG. 4, taken from a vantage point that is slightly above the embodiment depicted in FIG. 4 and looking downwardly thereon;

FIGS. 6A-E respectively represent bottom plan, front, side, rear, and top plan views of the embodiment depicted in FIGS. 4-5.

### DETAILED DESCRIPTION OF THE PREFERRED EMBODIMENT(S)

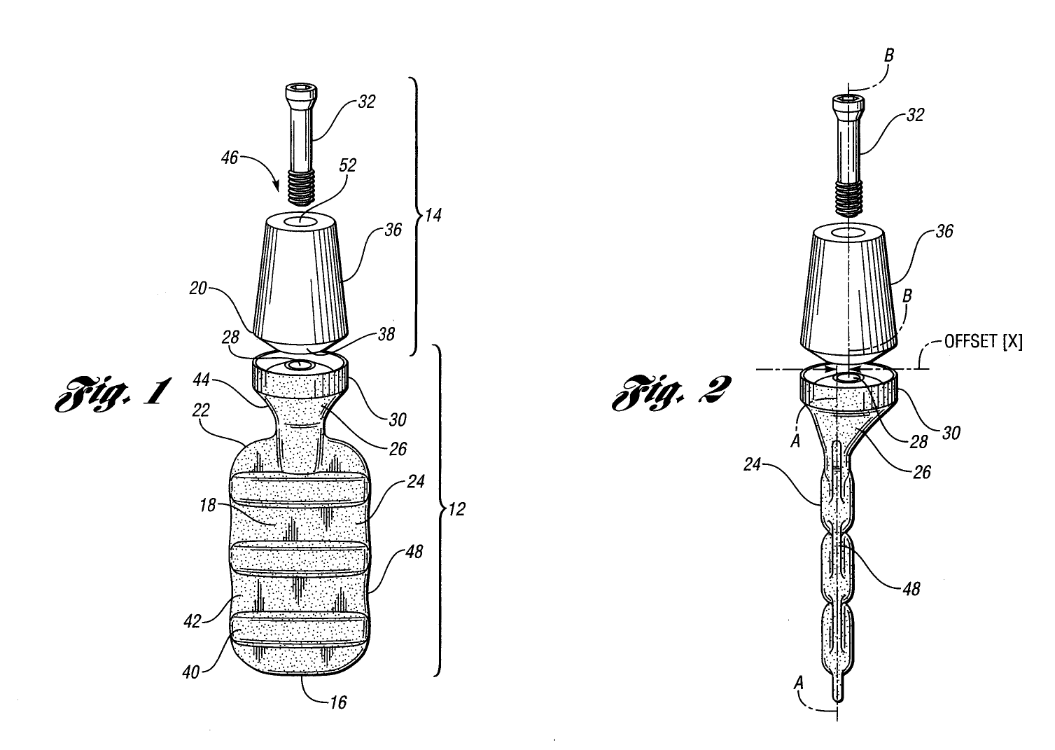

Referring first to FIGS. 1-3, the subject dental implant assembly 10 has in one embodiment a two-component abutment design 12,14 that receives cement, a threaded post 32 or a screw. One (lower) component 12 includes a foot 16, a core 18, a shoulder 22 and a bulging neck portion 26. The second (upper) component 14 (a low-profile permucosal extension) includes a frustoconical or barrel-shaped body 20 with a major 36 and a minor member 38 that are juxtaposed. The minor member 38 is seatable in a collar 30 of the bulging neck portion 26 of the lower component 14. The major member 36 extends upwardly from the minor member 38 that receives the threaded post 32 to retain a prosthesis (not shown) and permit a low tissue profile.

The neck or permucosal extension from the implant body may be configured as the bulging neck portion 26 to minimize stress at the crest. A thicker and more rigid post transmits less stress to the crestal bone around the implant. This increases both the mesiodistal and bucco-lingual size of the permucosal neck compared to traditional designs and thus can improve force distribution.

Preferably, a low-profile permucosal extension (the upper component 14) is first placed on the lower component 12 during the initial bone healing. Then the plate form implant system presents several advantages over a traditional one-piece fixed abutment blade-vent implant. A low tissue profile healing decreases the threat of trauma from masticatory forces or the tongue during formation of the bone-implant interface.

Furthermore, the two-piece (lower 12 and upper component 14) abutment system permits a prosthetic abutment to engage an antirotational hex, morse taper or other design which may permit an internal or external connection within the implant body. Examples are an internal or external hex with or without a morse taper.

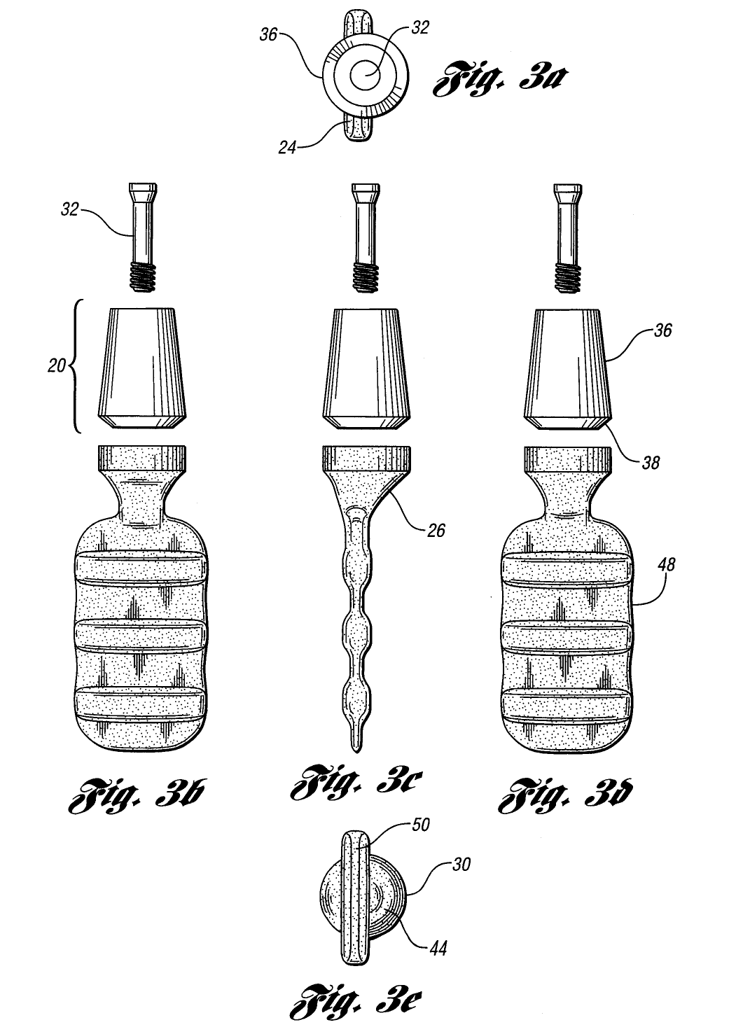

Turning now to FIG. 2, it will be appreciated that the plate 24 can be characterized by an axis A-A and that the receiving orifice 28 is offset by a dimension X therefrom. Thus, a prosthesis that is supported by post 32 can be offset or disposed more lingually in relation to the plate 24. In the example depicted, the upper component is characterized by a plane B-B. Thus, the lower component 12 lies in a lower plane A-A, and the upper component 14 lies in upper plane B-B. The upper plane is offset from the lower plane so that a prosthesis that is mounted on the upper component may be disposed in an offset manner in relationship to the lower component.

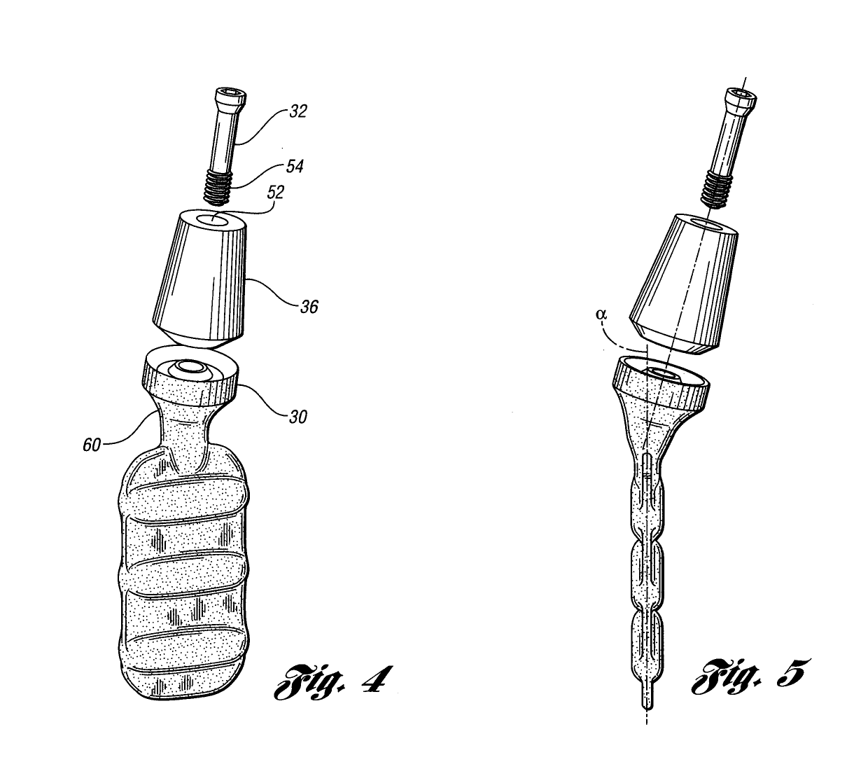

In several embodiments, the disclosed blade implant system also includes an angled or oblique bulging neck portion 60 (FIGS. 4-6). This permits inclined implant abutments to be used on the blade-vent implant core 18 to improve parallelism (align) with other teeth or implants and/or improve aesthetics. This eliminates the need to bend the abutment neck in situ to achieve parallelism with adjacent teeth and/or other implants.

In one embodiment, the mesiodistal dimension of each abutment region of the permucosal neck may be greater than 3 mm. This not only reduces stress at the crest of bone, but also increases the long-term strength of the implant and reduces risk of fatigue fracture.

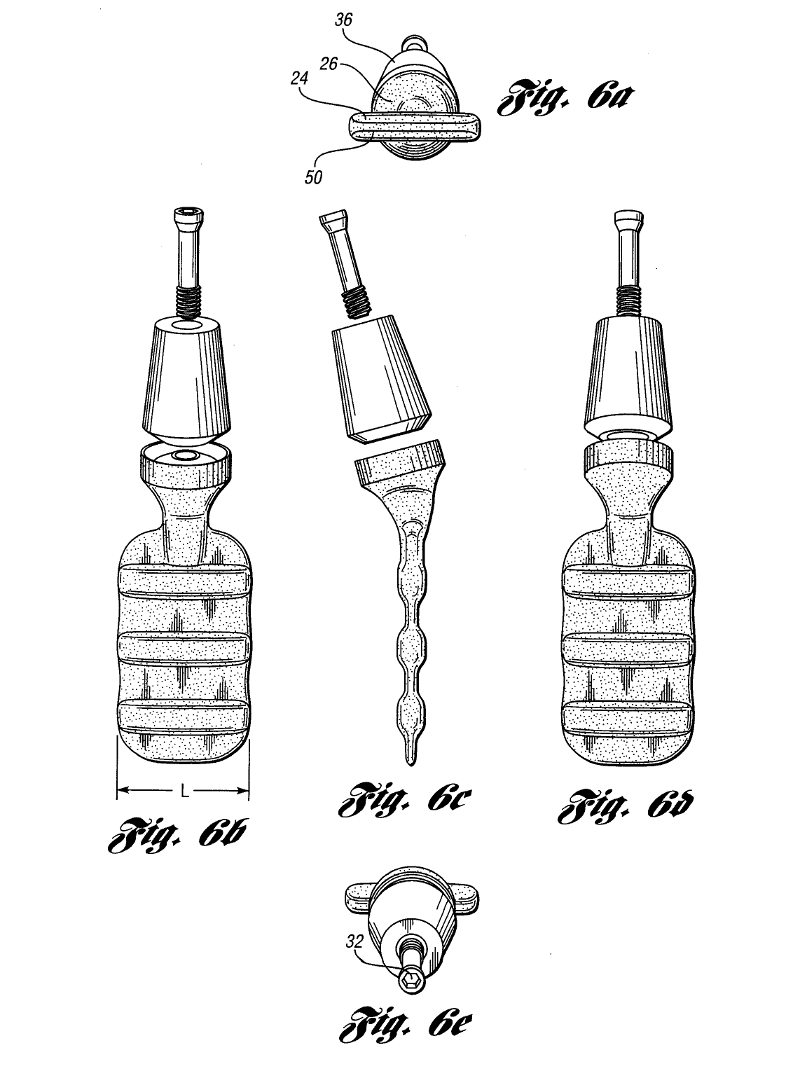

As noted earlier, traditional blade-vent implants may require in situ bending of the implant neck to develop parallelism between teeth and/or other implants. In the present inventive system, however, one embodiment of the implant abutment connection has a pre-formed angle (ALPHA—FIG. 5) between the core and the shoulder of the implant body. In one example, the angle of inclination lies between 10 and 40 degrees. As a non-limiting example, in FIGS. 4-6, the depicted angular displacement is 15 degrees. This feature may increase the strength of the implant in many cases.

Historically, blade implants were placed in a free hand osteotomy, prepared with a high speed handpiece and long, thin carbide drills. The long mesial-distal osteotomy was difficult to prepare, since curvature of the jaws was variable. The drills would often fracture during this process, and recovery of the broken component was difficult. As a remedy, the inventive system includes a method of placement. A piezzo electric or similar handpiece may use a cutting blade, of similar size and shape as the implant body. Hence the osteotomy is easier, is more precise and fracture of components is eliminated.

In the past, selection and acceptance factors for implant procedures considered implantation surgical technique, design and healing criteria. Fibrous tissue formation around the plate implant has proved to be predictable when used within specific conditions and guidelines. Conditions favoring rigid fixation of a plate form implant include a biocompatible material, an acceptable implant design, atraumatic hard and soft tissue preparation and implant placement, and a healing period without movement at the implant interface. Higher survival rates are reported in cases involving plate form implants with a direct bone implant interface or rigid fixation.

But there are advantages to a direct bone-implant interface other than improved survival rate. Long-term results are less dependent on peri-implant disease in the absence of fibrous tissue. This improves the quality of implant survival. Greater loads may be transferred to the bone without an increase in fibrous tissue and mobility to the implant, which further increases soft tissue complications.

Clinical assessment of the implant is easier with rigid fixation as provided by the present invention, because the healthy implant is immobile. A healthy fibrous tissue implant may have a range of mobility recordings. When mobility is permitted, the amount of movement related to direction and force is variable, and additional assessment experience by the practitioner is desirable. As a result, the practitioner is able to assess conditions more clearly with rigid fixation before the several appointments and laboratory costs of the final prostheses are incurred.

A traditional plate form of implant requires materials which are able to bend, yet have adequate strength. The traditional plate form implant is usually fabricated from commercially pure titanium. Commercially pure (CP) titanium is easier to adjust or be bent to follow a particular implant osteotomy. It may even be bent to fit the implant site while being seated in final position. In addition, the abutment post can be bent to align the prosthesis with natural teeth and/or other implants.

However, CP titanium has a 4× lower strength to fracture compared to titanium alloy. Accordingly, the present invention is an implant assembly designed to be shaped before deployment—not bent in situ—and be made of a more rigid and perhaps less expensive material, thus resisting weakening by fatigue fracture.

Here is a list of features and their respective reference numerals:

| Ref. No. | Feature |
|---|---|
| 10 | Implant assembly |
| 12 | Lower component |
| 14 | Upper component |
| 16 | Foot |
| 18 | Core |
| 20 | Barrel-shaped body |
| 22 | Shoulder |
| 24 | Plate |
| 26 | Bulging neck portion |
| 28 | Receiving orifice |
| 30 | Collar |
| 32 | Post |
| 36 | Major frustoconical portion |
| 38 | Minor frustoconical portion |
| 40 | Ridges |
| 42 | Valleys |
| 44 | Transition region |
| 46 | Threaded region (of 32) |
| 48 | Curvilinear side edge |
| 50 | Foot portion (of 24) |
| 52 | Post-receiving aperture of (36) |
| 54 | Threaded region (of 32) |
| 60 | Angled bulging neck portion |

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

I claim:

1. A dental implant assembly for implanting a prosthesis into the mouth of a patient, the dental implant assembly comprising:
a lower component including a foot, a core, a shoulder and a neck portion, the lower component being seatable in the bone structure of a patient;
an upper component that is detachably attachable to the lower component and includes a barrel-shaped body with major and minor members that are juxtaposed and adapted to have an artificial prosthesis secured thereto.

2. The dental implant assembly of claim 1, in which the lower portion includes laterally oriented ridges that lie between valleys for increasing bone-implant surface area.

3. The dental implant assembly of claim 2, in which the neck portion of the lower component includes a transition region that rises upwardly and outwardly from the shoulder portion for added strength and for increasing the surface area of the assembly which lies in contact with the bone.

4. The dental implant assembly of claim 3, further having a post extending between the upper component and the neck portion of the lower component.

5. The dental implant assembly of claim 1, in which the barrel-shaped body has a minor frustoconical portion with a post-receiving aperture that is seatable in the neck portion of the lower component; and
a major frustoconical portion extending from the minor frustoconical portion, the major frustoconical portion defining a post-receiving aperture that is co-axial with the post-receiving aperture of the minor frustoconical portion.

6. The dental implant assembly of claim 5, in which the post is receivable by the post-receiving aperture of the lower component, upon which the prosthesis may be secured.

7. The dental implant assembly of claim 6, wherein the post has a threaded region that is seatable in the post-receiving aperture.

8. The dental implant assembly of claim 1, in which the shoulder of the lower component is substantially horizontal.

9. The dental implant assembly of claim 1, in which the shoulder of the lower component inclines downwardly and outwardly from the neck portion.

10. The dental implant assembly of claim 2, in which at least one shoulder portion is rounded.

11. The dental implant assembly of claim 2, wherein the lower component has curvilinear side edges, between which the ridges and valleys extend.

12. The dental implant assembly of claim 5, in which the neck portion has a collar that forms a flat surface with the major frustoconical portion when the barrel-shaped body is seated upon the neck portion.

13. The dental implant assembly of claim 1 wherein the lower component lies in a lower plane and the upper component lies in an upper plane, the upper plane being offset from the lower plane so that a prosthesis that is mounted on the upper component may be disposed in an offset manner in relation to the lower component.

14. The dental implant assembly of claim 13 in which the upper component defines an axis that is inclined to the lower plane by an angle of inclination.

15. The dental implant assembly of claim 14 wherein the angle of inclination lies between 10-20°.

16. The dental implant assembly of claim 1 wherein the mesio-distal length of the core of the lower component is about 10-14 mm.

17. A method of positioning a dental implant, comprising:
forming a slotted anchoring site in a jaw bone;
inserting therewithin a dental implant assembly with a lower component having a foot, a core, a shoulder and a neck portion, the lower component being seatable in the bone structure of the patent, the dental implant assembly also having an upper component that is detachably attachable to the lower component, the upper component including a barrel-shaped body with major and minor members that are juxtaposed and adapted to secure a prosthesis.
